(19) United States
(12) Patent Application Publication
(10) Pub. No.: US 2012/0278216 A1
(43) Pub. Date: Nov. 1, 2012

(54) METHOD AND APPARATUS FOR SHARING A SELF-CREATED ACCOUNT FOR STORING ASSETS

(75) Inventors: John Anthony Evans, Helsinki (FI); Michiel Terlouw, Helsinki (FI)

(73) Assignee: Nokia Corporation, Espoo (FI)

(21) Appl. No.: 13/096,428

(22) Filed: Apr. 28, 2011

(51) Int. Cl. G06Q 40/00

(52) U.S. Cl. 705/35

(57) ABSTRACT

An approach is provided for sharing a self-created account for storing assets. An asset sharing platform determines at least one account for storing a representation of one or more associated assets. The at least one account is a self-created account associated with at least one device. The asset sharing platform further causes at least in part, a sharing of the at least one account with at least one other device to enable collective access to the at least one account by the at least one device and the at least one other device with substantially equal rights.

### BACKGROUND

Service providers and device manufacturers (e.g., wireless, cellular, etc.) are continually challenged to deliver value and convenience to consumers by, for example, providing compelling network services. The increased sophistication of such network services and devices allows for greater flexibility and ease of use. Consumers can now communicate more easily than ever before and can perform a wider array of tasks and transactions. Despite this increase in flexibility, network services are often restrained by the inflexibility of managing and sharing accounts storing assets that are transferred in performing many tasks and transactions over the network services. For assets such as money, consumers have only a few alternatives when conducting transactions. Money in the form of cash cannot be used for electronic transactions and is limited to physically possessing the cash. Banks accounts and credit cards allow for electronic transactions but are based on a formal and inflexible structure and thus cannot be created or shared with the ease and flexibility of many network services. As such, service providers face significant technical challenges to providing services that allow consumers to create, manage and share accounts that store assets to correspond with the ease and flexibility offered by other network services.

### SOME EXAMPLE EMBODIMENTS

Therefore, there is a need for an approach for sharing a self-created account for storing assets.

According to one embodiment, a method comprises determining at least one account for storing a representation of one or more associated assets, the at least one account being a self-created account associated with at least one device. The method also comprises causing, at least in part, a sharing of the at least one account with at least one other device to enable collective access to the at least one account by the at least one device and the at least one other device with substantially equal rights.

According to another embodiment, an apparatus comprises at least one processor, and at least one memory including computer program code, the at least one memory and the computer program code configured to, with the at least one processor, cause, at least in part, the apparatus to determine at least one account for storing a representation of one or more associated assets, the at least one account being a self-created account associated with at least one device. The apparatus is also caused, at least in part, to share the at least one account with at least one other device to enable collective access to the at least one account by the at least one device and the at least one other device with substantially equal rights.

According to another embodiment, a computer-readable storage medium carries one or more sequences of one or more instructions which, when executed by one or more processors, cause, at least in part, an apparatus to determine at least one account for storing a representation of one or more associated assets, the at least one account being a self-created account associated with at least one device. The apparatus is also caused, at least in part, to share the at least one account with at least one other device to enable collective access to the at least one account by the at least one device and the at least one other device with substantially equal rights.

According to another embodiment, an apparatus comprises means for determining at least one account for storing a representation of one or more associated assets, the at least one account being a self-created account associated with at least one device. The apparatus also comprises means for causing, at least in part, a sharing of the at least one account with at least one other device to enable collective access to the at least one account by the at least one device and the at least one other device with substantially equal rights.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30 and 44-47.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of sharing a self-created account for storing assets, according to one embodiment;

FIG. 2 is a diagram of the components of an asset sharing platform, according to one embodiment;

FIG. 3 is a flowchart of a process for creating a self-created account for storing assets, according to one embodiment;

FIG. 4 is a diagram of user interfaces utilized in the processes of FIG. 3, according to various embodiments;

FIG. 5 is a flowchart of a process for sharing a self-created account for storing assets, according to one embodiment;

FIGS. 6A and 6B are diagrams of user interfaces utilized in the processes of FIG. 5, according to various embodiments;

FIG. 7 is a flowchart of a process for using a shared self-created account for storing assets, according to one embodiment;

FIGS. 8A-8D are diagrams of user interfaces utilized in the processes of FIG. 7, according to various embodiments;

FIG. 9 is a diagram of a system capable of sharing a self-created account for storing assets, according to an exemplary embodiment;

FIG. 10 is a detailed diagram of a system capable of sharing a self-created account for storing assets, according to an exemplary embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for sharing a self-created account for storing assets are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention. Although various embodiments are discussed with respect to a system for sharing an asset account that stores money, it is contemplated that the system can share an account that stores any asset (e.g., cellular phone minutes, game credits, bandwidth allotments, phone credits, etc.).

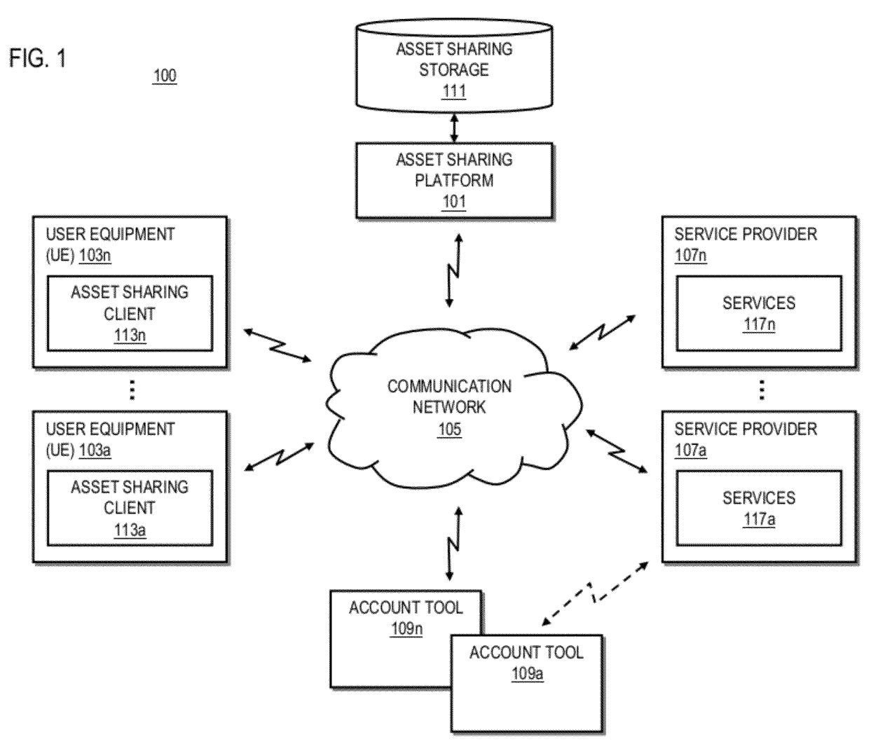

FIG. 1 is a diagram of a system capable of sharing a self-created account for storing assets, according to one embodiment. As previously noted, network services provided to consumers allow for greater flexibility and ease of conducting transactions and tasks. The network services and devices also allow for greater flexibility and ease between consumers communicating individually and in groups. Previously, a consumer would need to go to a store to buy their favorite artist's new album, whereas now the consumer can simply download the album from the comfort of their own home using a portable communication device. Further, friends planning a trip previously had to meet to organize all of the details of the trip and perhaps purchase airline tickets at a travel agency. Now, the friends can simply organize the trip over social networking services and pay for the airline tickets online using their communication devices.

Despite the increased ease that modern services provide consumers in conducting business online and socializing in groups, methods for paying for the business or associating assets while socializing in groups are still not as flexible as the modern services. This inflexibility is often seen when friends plan to go on vacation together. To ensure that the friends sit near each other on the flight to their destination, often one friend has to purchase the airline tickets for the entire group. Thus, the one lucky friend has to use his or her own bank account to pay for all of the tickets. While socializing on vacation, such as eating meals and having drinks, often one friend will usually buy a round of drinks or a meal for the entire group. Again, the lucky friend stuck with the bill will have to use his or her own bank account to pay for the meal or drinks. Although the friends can pool together a large amount of cash for the vacation, carrying a large amount of cash is not secure and using the cash is limited to having the cash in hand, which only one friend can have at a time.

One option to avoid such problems discussed above is to create a shared bank account between the friends so that all of the friends can share their money before the vacation. However, setting up an account for even one individual takes a lot of time and the procedures require filling out many forms, signing many documents, and waiting for the third-party organization managing the account to open the account. When friends attempt to open shared accounts, the number of forms and signatures multiplies thereby further adding to the hassle of opening an account to the point where the hassle prevents opening up shared accounts between friends simply for a vacation. This inflexibility is magnified when compared to the flexibility of network services consumers use on a daily basis. Thus, the flexible services can still be burdened by the inflexible methods for creating, managing, sharing and using assets and accounts.

To address this problem, a system 100 of FIG. 1 introduces the capability for a user to share self-created accounts that store assets with other users between at least two user devices and to enable collective access between the two devices with substantially equal rights. In one embodiment, the system 100 provides for a method for a user self-creating an account with a cell phone that stores a representation of money and sharing the account with another user's cell phone without any external authorization. The two users then enjoy collective access to the account through the cell phone and both users have substantially equal rights in the account.

By way of example, a user can deposit money at a kiosk or with a vendor who then transfers the money to an account the user created that the user can access through, for example, a cell phone. As discussed above, the user can then share the account with a friend if, for example, the two friends are planning to go on vacation together. With substantially equal rights in the account, both friends can withdraw and deposit money in the account in preparation for the vacation. While on vacation, the friends can pay for the vacation-related activities with money from the account. Because the accounts are created without any external authorization from, for example, a bank, additional accounts can be created on the spot. By way of example, the friends can decide to pool money together from the vacation account to open another account specifically for going to a casino while on vacation. Because the accounts are associated with the cell phones, both friends have access to the account wherever they carry their cell phone. Thus, the possibility of sharing self-created accounts adds to the friends' enjoyment of the vacation.

As shown in FIG. 1, the system 100 comprises user equipment 103a-103n (collectively referred to UE 103), account tools 109a-109n (collectively referred to as account tool 109), and service providers 107a-107n (collectively referred to as service providers 107) all having connectivity to an asset sharing platform 101 via a communication network 105. The UE 103a-103n include asset sharing clients 113a-113n (collectively referred to as asset sharing client 113) that are applications running on the UE 103 that communicate with the asset sharing platform 101. The asset sharing platform 101 stores information regarding the shared assets and accounts created by the UE 103 in the asset sharing storage 111. The service providers 107 include services 117a-117n (collectively referred to as services 117) (e.g., social networking services, banking services, credit services, information services, retail services, consumer services, etc.) that interact with the UE 103, account tools 109a-109n and the asset sharing platform 101.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 103 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 103 can support any type of interface to the user (such as “wearable” circuitry, etc.).

By way of example, the UE 103, asset sharing platform 101, account tools 109 and service providers 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

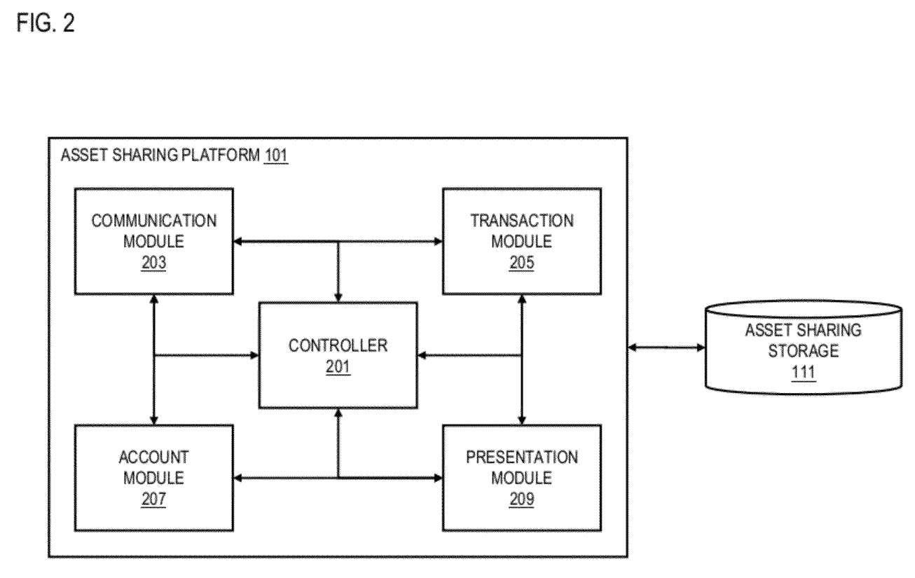

FIG. 2 is a diagram of the components of the asset sharing platform 101, according to one embodiment. By way of example, the asset sharing platform 101 includes one or more components for sharing a self-created account for storing assets. It is contemplated that the functions of these components may be combined in one or more components or performed by other components of equivalent functionality. For example, in other embodiments the functions of the components of the asset sharing platform 101 may be performed by components of the UE 103 or may be performed by the asset sharing client 113 or may be performed by one of the service providers 107. As illustrated in FIG. 2, in this embodiment the asset sharing platform 101 includes at least a controller 201, a communication module 203, a transaction module 205, an account module 207 and a presentation module 209.

As shown in FIG. 2, the controller 201 controls the other modules of the asset sharing platform 101. Communications between the asset sharing platform 101 and the asset sharing storage 111 or the other components of the system 100 generate from the communication module 203. The asset sharing platform 101 communicates with the asset sharing storage 111 to store information used by the asset sharing platform 111. The account module 207 tracks the account creation, management and sharing within the asset sharing platform 101 and links the corresponding information regarding the accounts stored in the asset sharing storage 111 with each account associated with the asset service clients 113 of the corresponding UE 103. The transaction module 205 tracks transactions for each account so that information regarding the transactions is stored in the asset sharing storage 111 associated with the particular transaction and account. The presentation module 209 formats the information sent to the asset sharing client 113 of the UE 103 for each transaction of each account for display on the user interface of the UE 103.

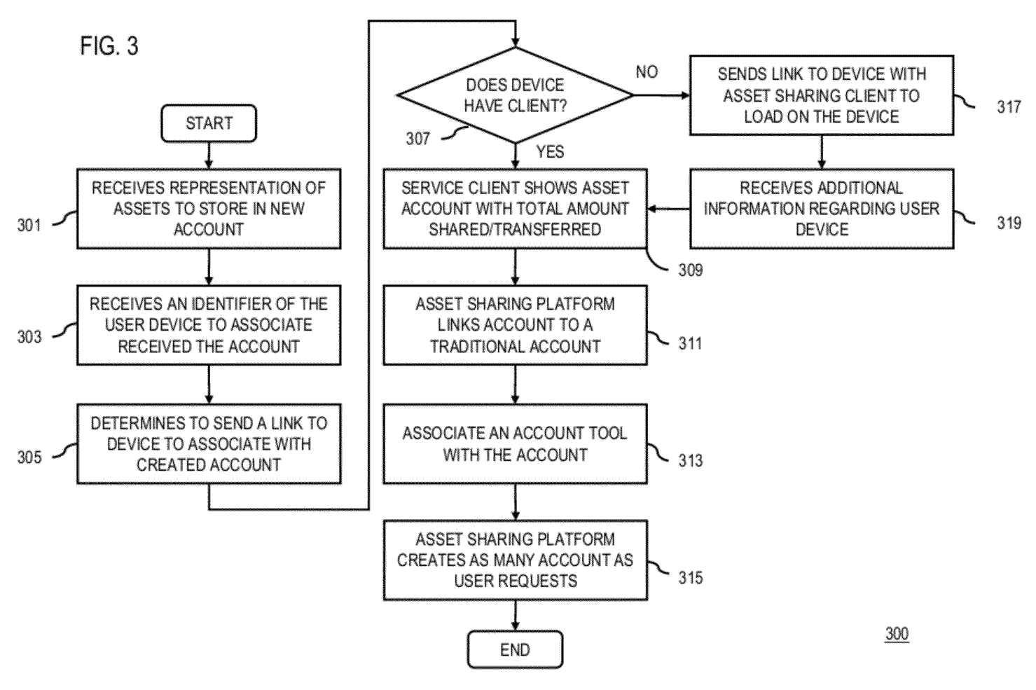

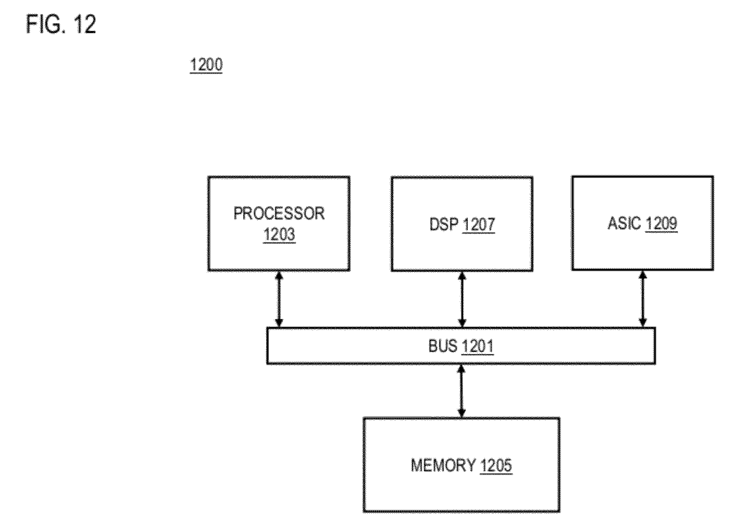

FIG. 3 is a flowchart of a process for loading the asset sharing client 113 on the UE 103 and creating a self-created account for storing assets, according to one embodiment. In one embodiment, the asset sharing platform 101 performs the process 300 and is implemented in, for instance, a chip set including a processor and a memory as shown in FIG. 12.

In step 301, the asset sharing platform 101 receives a request for a new account with a new representation of assets to be stored in the account. In one embodiment, a user goes to an asset sharing agent service provider 107f and requests to create an account and to associate the account with the user's UE 103. The user will also request that the account store a certain amount of an asset. The asset sharing agent service provider 107f will then enter information regarding the amount of the asset that the user wants to deposit into the account. The asset sharing agent service provider 107f uses a UE 103 as a vendor tool with an asset sharing client 113 already loaded and connected to the asset sharing platform 101 to conduct the transaction. The vendor enters the amount of the asset that the user wants to associate with the account in the UE 103 vendor tool and transmits this amount to the asset sharing platform 101. This amount is then received at the asset sharing platform 101. In this embodiment, the user is using the asset sharing agent service provider 107f merely to associate the UE 103 with the asset sharing platform 101. In the same instance, the user is creating the first account but creation of the account is not necessarily dependent on the asset sharing agent service provider 107f.

In one embodiment, a user can request to create an account and to associate the account with the user's UE 103 through a banking service provider 107e running a service 117e that communicates with the asset sharing platform 101. Here, the user enters the amount of the asset that the user wants to associate with the account and the asset sharing platform 101 receives this amount and associates it with the account. By way of example, the banking service provider 107 e is a bank that the user already has a banking account with, and the user requests to transfer assets from the bank account to the account held through the asset sharing platform 101. In this embodiment, the user is using the asset sharing agent service provider 107f merely to associate the UE 103 with the asset sharing platform 101. In the same instance, the user is creating the first account but creation of the account is not necessarily dependent on the asset sharing agent service provider 107f.

In one embodiment, the user has already loaded the asset sharing client 113 on the user's UE 103. Thus, the user can send a request to the asset sharing platform 101 directly from the user's UE 103 through the asset sharing client 113 to create a new account. The user then simply requests that assets be transferred from an existing account to the new account. In this embodiment, the account is created without the need of forms or signatures.

In step 303, the asset sharing platform 101 receives an identifier identifying the specific UE 103 that the account will be associated with. In one embodiment, the UE 103 is a cell phone and the identifier is the unique phone number that is associated with the cell phone. In one embodiment, the UE 103 is a cell phone and the identifier is the unique SIM card number associated with the cell phone. In one embodiment, where the UE 103 already has the asset sharing client 113 loaded, the request to create a new account has the identifier embedded in the request.

In step 305, after receiving the request to create an account, the amount of the asset that will be in the account and the identifier that associates the account with a specific UE 103, the asset sharing platform 101 sends a link to the UE 103 to associate the UE 103 and the asset sharing client 113 running on the UE 103 with the account. In one embodiment, the UE 103 is a cell phone and the asset sharing platform 101 sends a message (e.g., e-mail, SMS, MMS, social networking communication, etc.) to the cell phone with a link to the created account. In one embodiment, the UE 103 is a cell phone already running the asset sharing client 113 and the message is simply to add another icon in the user interface of the asset sharing client 113 that includes the newly created account (discussed below).

In step 307, the asset sharing platform 101 determines whether the UE 103 identified by the identifier is already registered in the asset sharing storage 111 and therefore should already have the asset sharing service 113 running on the UE 113. If the asset sharing platform 101 determines that the UE 103 is not already in the system, the process 300 proceeds to step 317. If the asset sharing platform 101 determines that the UE 103 is already in the system, the process 300 proceeds to step 309. In one embodiment, steps 305 and 307 are unique, discrete steps that occur in the order as illustrated in FIG. 3 (i.e., step 305 precedes step 307). In one embodiment, steps 305 and 307 are unique, discrete steps that occur in the opposite order as illustrated in FIG. 3 (i.e., step 307 precedes step 305). In one embodiment, steps 305 and 307 occur as one step and a determination is made whether the UE 103 already is in the system and, therefore, whether an asset sharing service 113 is already running on the UE 103. After the determination is made, a proper message is sent that includes the link to load the asset sharing client 113 and the link to the account or only the link to the account.

In step 317, the asset sharing platform 101, after determining that the UE 103 needs to load the asset sharing client 113, sends a link to the UE 103 to load the asset sharing client 113. In step 319, after the UE 103 loads the asset sharing client 113, the asset sharing platform 101 receives additional identification information regarding the UE 103 (e.g., user address, birthday, family members, other contact information, etc.) and associates the information in the asset sharing storage 111.

In step 309, the asset sharing platform 101 sends information to the UE 103 through the asset sharing client 113 that indicates the created account with the total amount of assets in the account. In one embodiment, the UE 103 is a cell phone and the asset sharing platform 101 sends information to the UE 103 that displays the account as a box labeled by a name that is selected by the user and associated with a picture selected by the user (discussed below).

In step 311, if the user chooses, the asset sharing platform 101 can link the account to a traditional account (e.g., checking account, savings account, money market account, mutual fund, credit card account, etc.). Thus, the user can then directly deposit assets from a traditional account into the self-created account held through the asset sharing platform 101 using the asset sharing platform 101.

In step 313, the asset sharing platform 101 links the account to a payment tool 109. In one embodiment, the payment tool 109 is an NFC key fob. In one embodiment, the payment tool 109 is an NFC card. In one embodiment, the payment tool 109 is a card formatted and structured similarly to a credit card with a magnetic strip that can be swiped to access information regarding the associated account. In such an embodiment, the payment tool 109 can be used at locations that accept traditional credit card services (e.g., VISA, MasterCard, American Express, etc.). In one embodiment, the payment tool 109 has a unique identifier string on the exterior surface that allows the user to link to the account associated with the payment tool 109 for online transactions that accept traditional credit card numbers.

In step 315, once the account is created with the asset sharing platform 101, or the asset sharing client 113 is loaded on the UE 103 and the first account is created, the user can create as many accounts as desired starting over at step 301 (as further discussed below).

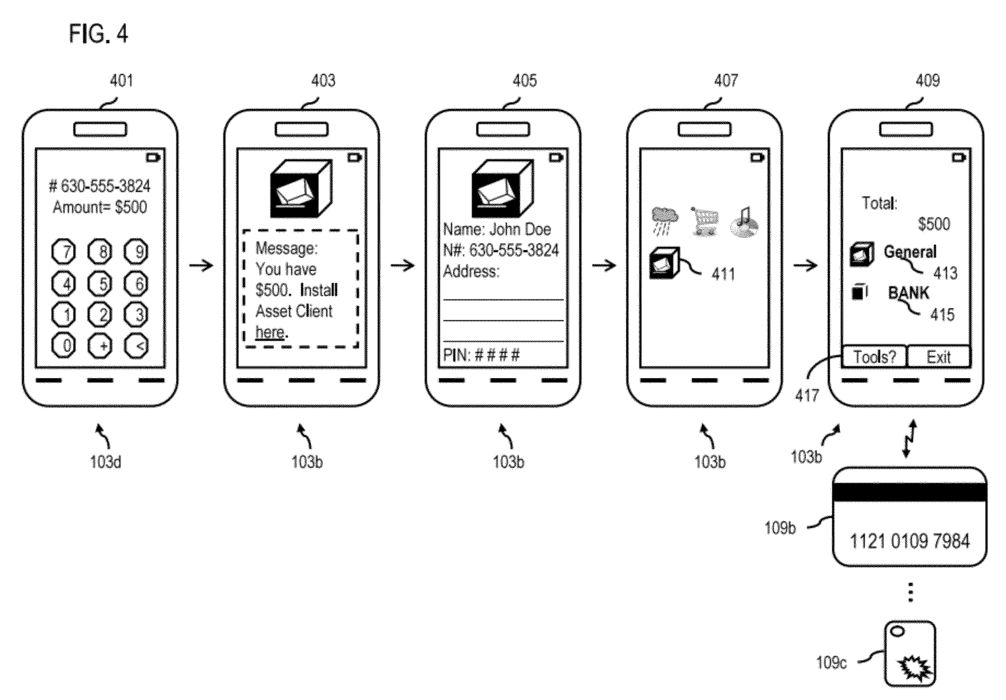

FIG. 4 is a diagram of user interfaces utilized in the processes of FIG. 3, according to various embodiments. Indicator 401 is the user interface of UE 103d utilized as a vendor tool by an asset sharing agent service provider 107f when a user wants to deposit an asset into an account. As discussed above, indicator 401 illustrates the vendor entering the number that identifies the specific UE 103b that the account will be associated with in addition to the amount of the asset that will be stored in the account. Indicator 401 also indicates that the UE 103d vendor tool includes numeric inputs for entering the information regarding the identifier and the amount. Indicator 403 is the user interface of the user's UE 103b when the UE 103b receives the message from the asset sharing platform 101 regarding the account being created and the amount of assets that are stored in the account. The indicator 403 also shows the underlined linked that can be accessed by the user to download the asset sharing client 113 from the asset sharing platform 101 if the UE 103b does not already have the client. Indicator 405 illustrates, in the event the UE 103b did not previously have the asset sharing client 113 running, the additional information the user provides the asset sharing platform 101 in step 319 discussed above. Included in indicator 405 is a PIN number that the user can set for extra security in using the account through the asset sharing platform 101 (discussed in detail below). In one embodiment, when entering the number that identifies the specific UE 103b with the UE 103d vendor tool at indicator 401 discussed above, the user can enter the PIN number at this step.

Indicator 407 shows the asset sharing client 113 icon 411 among the other icons associated with possible other software applications running on the UE 103. In the event that the UE 103b did not previously have the asset sharing client 113 loaded, the asset sharing client 113 icon 411 lets the user know that the asset sharing client 113 is now loaded on the UE 103b. Accessing the icon 411 accesses the asset sharing client 113.

Indicator 409 shows the view of a specific account, for example the general account 413 that stores, for example, $500 in assets. Indicator 409 also shows a traditional account 415 that is linked to the general account 413. As discussed above, the traditional account 415 can comprise, for example, a checking account, a savings account, a money market account, a mutual fund or a credit card account. By linking a traditional account 415 with the general account 413, the user can transfer funds between the two accounts. Associated with indicator 409 is indicator 417 that allows a user to associate an account tool 109 with the general account 413. In one embodiment, the user associates a credit card style account tool 109b with the general account 413 to be able to access the assets stored in the general account 413 at stores that accept credit card style payments using magnetic strips or through electronic retailers that accept credit card number payments online. In one embodiment, the user associates an NFC key fob style account tool 109c with the general account 413 to be able to access the assets stored in the general account at locations that accept NFC devices.

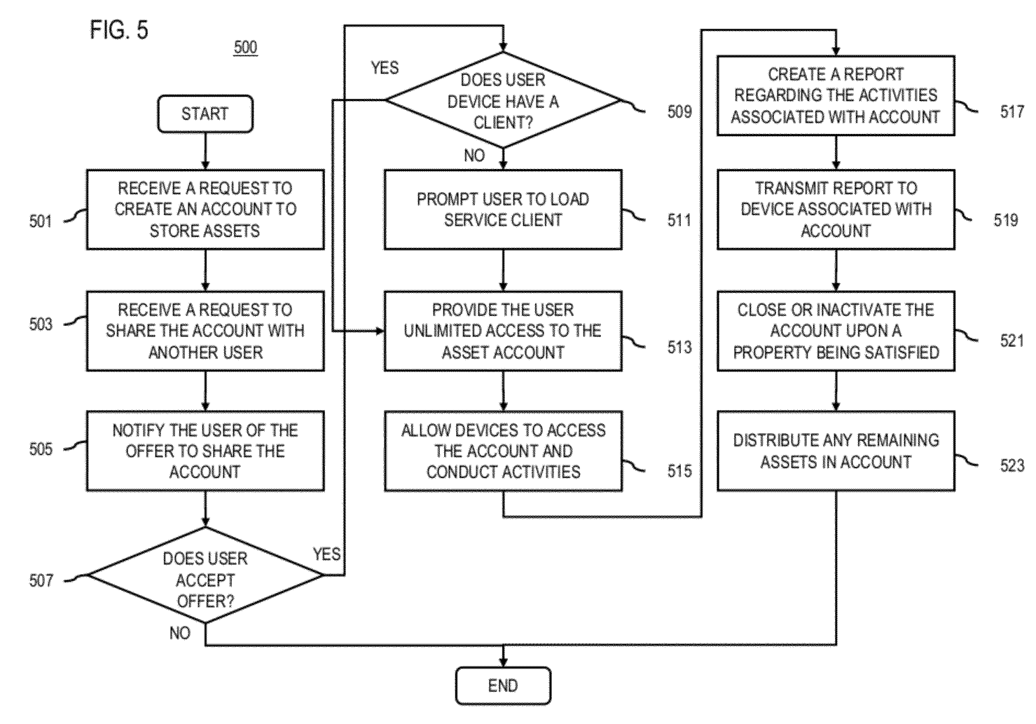

FIG. 5 is a flowchart of a process for sharing a self-created account for storing assets, according to one embodiment. In one embodiment, the asset sharing platform 101 performs the process 500 and is implemented in, for instance, a chip set including a processor and a memory as shown in FIG. 12. In step 501, the asset sharing platform 101 receives a request to create an account to store assets from a UE 103b through the asset sharing client 113 running on the UE 103b. Is this embodiment, there is no external authorization or substantial interaction required to create the new account. Accordingly, the time required to create the account is almost instantaneous without requiring any forms or signatures. In one embodiment, the asset sharing platform 101 receives the request from a user of a cell phone that initiates a request to create new account and transfers money from a current account to the new account. In this embodiment, there is no external authorization or substantial interaction required to create the new account. Accordingly, the time required to create the account is almost instantaneous without requiring any forms or signatures. In one embodiment, a user of a cell phone deposits money at a kiosk and the asset sharing platform 101 receives the request from the kiosk to create a new account and associate the account with the UE 103b. In this embodiment, despite there being limited external interaction with the user using the kiosk, the interaction is minimal and does not amount to any external authorization to create the account. Thus, creation of the account is controlled by the decision of the user of the UE 103b to create the account. Accordingly, the time required to create the account is almost instantaneous without requiring any forms or signatures.

In step 503, the asset sharing platform 101 receives a request to share the created account with a UE 103c that is associated with another user. In one embodiment, a user operating a cell phone requests that the asset sharing platform 101 share the created account with a friend listed in the user's cell phone address book. In one embodiment, a user requests the asset sharing platform 101 share an account that was previously created and already listed in the asset sharing client 113 of the UE 103b with a friend listed in the user's cell phone address book. Thus, in one embodiment, the process 500 can start at step 503 if the account that the user of the UE 103b wants to share was previously created.

In step 505, the asset sharing platform 101 notifies the UE 103c of the request to share the account from the UE 103b. In one embodiment, the notification is in the form of a message (e.g., e-mail, SMS, MMS, social networking communication, etc.) from the asset sharing platform 101. In step 507, the asset sharing platform 101 determines whether the UE 103c accepts the notification to share the account. If the UE 103c accepts the notification to share the account, the process 500 proceeds to step 509. If the UE 103c declines the notification to share the account, the process 500 ends. In one embodiment, if the UE 103c declines the notification to share the account, the asset sharing platform 101 notifies the UE 103b that the UE 103c declined the notification to share the account.

In step 509, the asset sharing platform 101 determines whether the UE 103c is registered in the system as already having the asset sharing client 113 loaded. If the asset sharing platform 101 determines that the UE 103 is not in the system, in step 511, the asset sharing platform 101 prompts the UE 103c to load the asset sharing client 113.

After step 511, or if the asset sharing platform 101 determines that the UE 103c is registered in the system, in step 513 the asset sharing platform 101 provides the UE 103c with collective access to the shared account with substantially equal rights as the UE 103b. In one embodiment, upon receiving collective access to the account, users of the UE 103b and the UE 103c can use the account without any limitations. Because of the collective access with substantially equal rights, no one user or one UE 103 acts as the administrator or owner over the account. Both UE 103 can deposit money in the account for any reason and can withdraw money from the account for any reason. In one embodiment, there are no authorizations or spending limits associated with the account. Rather, use of the account between the two devices is based on trust of the users that share the account (e.g., close friends, business partners, family members, etc.). In one embodiment, a shared account can have a general purpose based, for example, on the name of the account. By example, an account called “Groceries” stores assets that are intended to be used for buying groceries. Despite the name of the account, any user that shares access to the account can transfer money out of the account for any purpose, even for buying goods that are not considered groceries. Equal rights over the account also allows for other users that are granted access to the shared account can give additional users access the account.

In one embodiment, an account can be created with one or more limitations that apply equally to all users that share collective access. In one embodiment, an account can be created that requires a user to deposit assets into the account in order to gain access. In one embodiment, an account can be created that has a maximum or minimum amount of the assets that can be transferred into or out of the account with any one transaction. In one embodiment, an account can be created that has a maximum or minimum level for the asset for the account to remain open. In one embodiment, the use of the account can be limited to a certain context (e.g., location, time, purpose, type of access in the account). In one embodiment, an account can have a set lifespan based on, for example, an amount of time, a number of users that continue to have collective access to the account, etc. In one embodiment, the account can have security features such as requiring the user to enter an identification challenge (e.g., PIN number, password) to access the account. In one embodiment, the account only requires the user to enter an identification challenge if the amount for a particular transaction exceeds a threshold amount. In one embodiment, an account can be created for a special purpose, such as to collect money for a birthday or to collect money to donate to a charity. In one embodiment, an account can be created and associated with a goal, for example saving money to buy a bike. The account can be associated with a service provider 107 that sells the bike. The asset sharing platform 101 through the asset sharing client 113 can notify the user of the UE 103 when the price of the bike offered by the service provider 107 is below the amount stored in the account. In one embodiment, despite certain limitations being placed on an account when the account is created, once users share collective access over the account, the users enjoy substantially equal rights over the account subject to the limitations placed on the account. In one embodiment, regardless of the limitations being placed on an account when the account is created, once users share collective access over the account, the users enjoy substantially equal rights over the account and can change the limitations placed on the account when the account was created at any time.

In step 515, the asset sharing platform 101 allows the devices to access the account and monitors the account for any transactions associated with the UE 103b and UE 103c. In step 517, the asset sharing platform 101 creates reports regarding the activities associated with the account. In one embodiment, the asset sharing platform 101 logs the location, amount, type, time, method, etc. of any activity associated with the account and the user and/or UE 103 that conducted the activity. By way of example, in one embodiment, the asset sharing platform 101 logs that the user of UE 103b bought beer at the local convenience store at 10 PM for $10 using an account tool 109. By way of example, in one embodiment, the asset sharing platform 101 logs that the user of UE 103b deposited $100 into the account using an asset sharing agent service provider 107f. The information created in the reports is logged in the asset sharing storage 111.

In step 519, the asset sharing platform 101 transmits to the UE 103b, the UE 103c, or a combination thereof reports regarding activities associated with the account. In one embodiment, the asset sharing platform 101 transmits the reports in substantially real-time, periodically, on demand, according to a schedule, or a combination thereof. In one embodiment, the asset sharing platform 101 transmits the entire report. In one embodiment, the asset sharing platform 101 transmits a truncated version of the report. In one embodiment, the asset sharing platform 101 transmits the report to all of the devices that share collective access to the shared account. In one embodiment, the asset sharing platform 101 transmits the report to all of the devices that share collective access to the shared account except for the device that originated the transaction that caused the creation and transmission of the report. In one embodiment, where an account was created to store assets related to a particular kind of transaction, the asset sharing platform 101 transmits a report in response to assets being transferred out of the account for a purpose other than the particular kind of transaction. In this embodiment, other users that share collective access over the account can then create a dialogue with the user that used the account for reasons other than the intended purpose. By way of example, in one embodiment, the asset sharing platform 101 transmits the message to the devices that share collective access to the account using any one of an e-mail, SMS, MMS, social networking communication, etc., or a combination thereof. In one embodiment, the asset sharing platform transmits the report in the form of a map that illustrates the locations and amounts of the transfers across the map.

In step 521, the asset sharing platform 101 determines that one or more conditions are met that results in closing or suspending the account. As discussed above, the shared account can be created for a particular purpose or have a particular lifespan. Upon the completion of the particular purpose or the particular life span, in one embodiment the asset sharing platform 101 automatically closes the account. In one embodiment, the asset sharing platform 101 prompts the users for permission before closing the account. In one embodiment, the asset sharing platform 101 prompts the users for permission before closing the account and requires at least a majority of the users to select to close the account before actually closing the account.

In step 523, after closing the account, the asset sharing platform 101 distributes any remaining portion of the assets within the shared account to the devices that shared collective access to the account. In one embodiment, the devices that shared collective access to the account receive equal shares of the remaining assets in the closed account. In one embodiment, the devices that shared collective access to the account receive shares that are proportional to the contributions deposited into the account by the respective devices. After closing the account and distributing the assets, the process 500 ends.

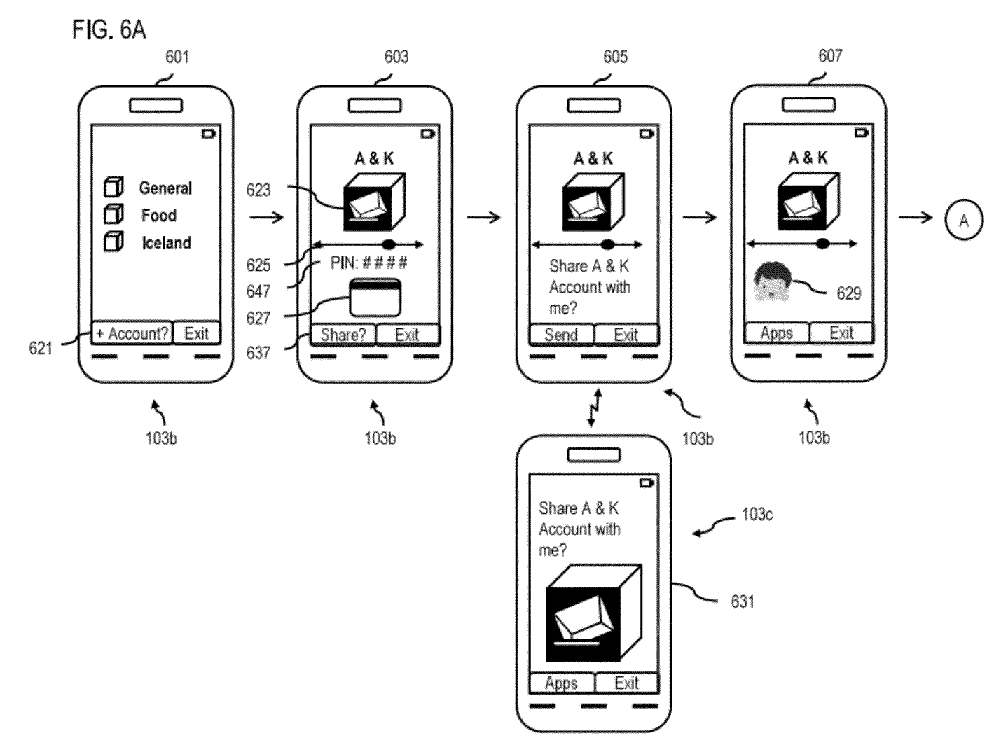

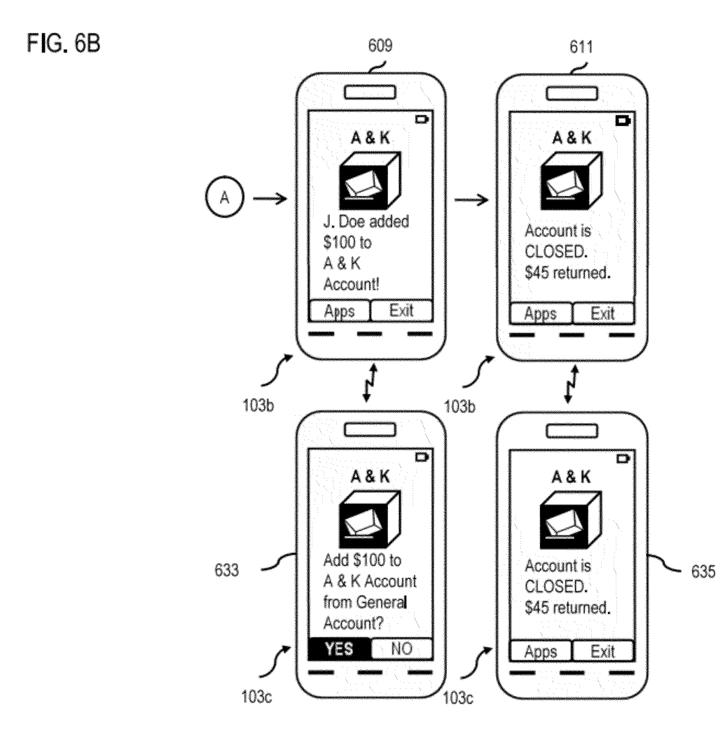

FIGS. 6A and 6B are diagrams of user interfaces utilized in the processes of FIG. 5, according to various embodiments. In FIG. 6A, indicator 601 is the user interface of UE 103b that lists the various self-created accounts by the user of the UE 103b. In one embodiment, there are three accounts, one for general activities, one for food related activities and one for planning a trip to Iceland. The indicator 601 also includes indicator 621 that allows for the addition of accounts upon the user selecting indicator 621.

Upon selecting indicator 621, the user interface shows indicator 603 that illustrates the newly created account named A & K. In one embodiment, the user can select any name for the newly created account. The Indicator 603 includes indicator 623 that is a graphical representation of the account. In one embodiment, the user can modify the indicator 623 to be any desired picture. In one embodiment, the indicator 603 also includes indicator 625 that allows for adjusting certain properties on the account, such as setting the limitations discussed above. If the account is associated with an account tool 109, the indicator 603 includes indicator 627 that illustrates that an account tool 109 is associated with the account and the type of account tool 109. Indicator 603 also includes indicator 647 that illustrates whether a PIN number has been associated with the account. Selecting indicator 647 allows for the user to modify the PIN number. Also included in indicator 603 is indicator 637 that allows for the user of the UE 103b to share the active account with another device through the account sharing platform 101.

Indicator 605 illustrates a message that will be sent to the UE 103c to request to share the A & K account with the UE 103b. Upon sending the request, as discussed above, the UE 103c displays indicator 631 with the message to the other user and the graphical representation of the account. Upon the UE 103c accepting the request to share the account, the user interface of UE 103b displays indicator 607 that has the account name, the graphical representation of the account, and a graphical representation of the other user 629 with whom the account was shared.

In FIG. 6B, indicator 633 illustrates the user interface of the UE 103c requesting whether to proceed with adding assets to the shared account. In one embodiment, the user of the UE 103c is presented with a yes or no choice for adding assets to the shared account. In response to the UE 1003c adding funds to the shared account, the asset sharing platform 101 generates and transmits a message to the devices associated with the shared account. Indicator 609 illustrates the user interface of the UE 103b including the report generated by the asset sharing platform 101 after the UE 103c added assets to the shared account. In one embodiment, the report is an SMS message indicating that the UE 103c added $100 to the A & K account. After using the shared account and, in the event that the account is closed, indicator 611 displays on the UE 103b and indicator 635 displays on the UE 103c a message sent from the asset sharing platform 101 that the shared account is closed. Indicators 611 and 635 also indicate the distribution of the funds that were remaining in the account at the time the account was closed.

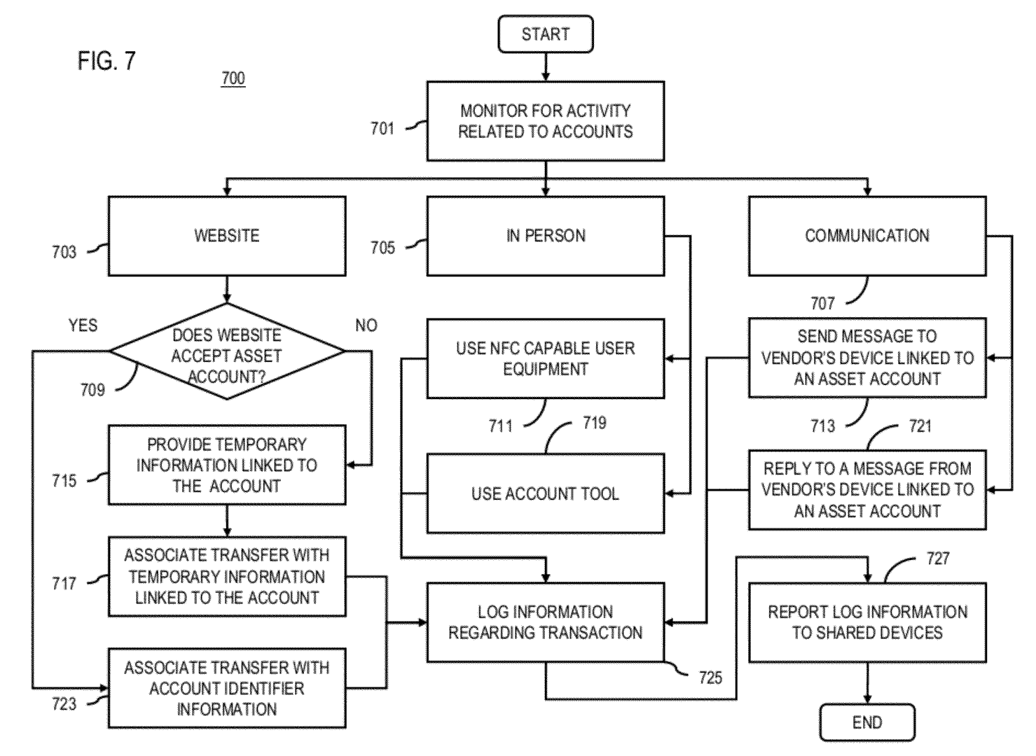

FIG. 7 is a flowchart of a process for using a self-created account storing assets based on various different methods, according to one embodiment. In one embodiment, the asset sharing platform 101 performs the process 700 and is implemented in, for instance, a chip set including a processor and a memory as shown in FIG. 12. In step 701, the asset sharing platform 101 monitors for activity related to the shared accounts, particularly for transfers in the accounts. When performing transfers associated with the account, there are several routes. The process 700 proceeds to step 703 for transfers made via a website, to step 705 for transfers made in person, and step 707 for transfers made via a communication. For transfers made via a website, the process 700 proceeds to step 709 where it is determined whether the website complies with the asset sharing platform 101. If the website complies with the asset sharing platform 101, the process 700 proceeds to step 723. If the website does not comply with the asset sharing platform 101, the process proceeds to step 715. In step 715, the asset sharing platform 101 provides the UE 103 conducting the transfer with temporary information linked to the asset account. In one embodiment, the temporary information is formatted to correspond with information required to conduct transactions via a credit card on a website. In step 717, the temporary information can then be used with the website to associate a transfer of assets with the purchase made over the website. In step 723, the asset sharing platform 101 associates the transfer with the account identifier information already present in the asset sharing storage 111 discussed above. In one embodiment, the asset sharing platform 101 associates the transfer with the account name and a phone number associated with the account name if the UE 103 is a cell phone. In step 725, after associating the account with the transfer, the asset sharing platform 101 logs information regarding the transaction in the asset sharing storage 111, as discussed above. In step 727, the asset sharing platform 101 reports the information stored in the asset sharing storage 111 to all or a combination of the devices associated with the account, as discussed above.

For transfers made via strictly in person, the process 700 proceeds to step 711. In step 711, the asset sharing platform 101 monitors for an NFC indication from the asset sharing client 113. In one embodiment, when transferring assets to a third party, a UE 103 that is NFC capable can transfer assets simply by tapping the UE 103 vendor tool of the third party if the third party UE 103 is also NFC capable. In step 719, account tools 109 can be used to transfer assets. In one embodiment, when transferring assets to a third party, account tools 109 that are NFC capable can transfer the assets simply by tapping the UE 103 vendor tool of the third party if the third party UE 103 is also NFC capable. In one embodiment, when transferring assets to a third party, account tools that are structured according to current credit card standards can be swiped by the UE 103 to transfer the assets. Following step 711 or step 719, the process 700 proceeds to steps 725 and 727, as discussed above.

For transfers made via a communication, the process 700 proceeds to step 713 or step 721. In step 713, a user can send a message (e.g., e-mail, SMS, MMS, social networking communication) to transfer the assets. In one embodiment, the user formats an SMS message simply by typing in the name of the account from which the assets will be transferred from, the amount that will be transferred, and a brief message regarding why the transfer is occurring. In step 721, the asset sharing platform 101 can send a message to a user's UE 103 to prompt for payment and the UE 103 can respond to the prompt with a message as formatted above with respect to step 713. Following step 711 or step 719, the process 700 proceeds to steps 725 and 727, as discussed above.

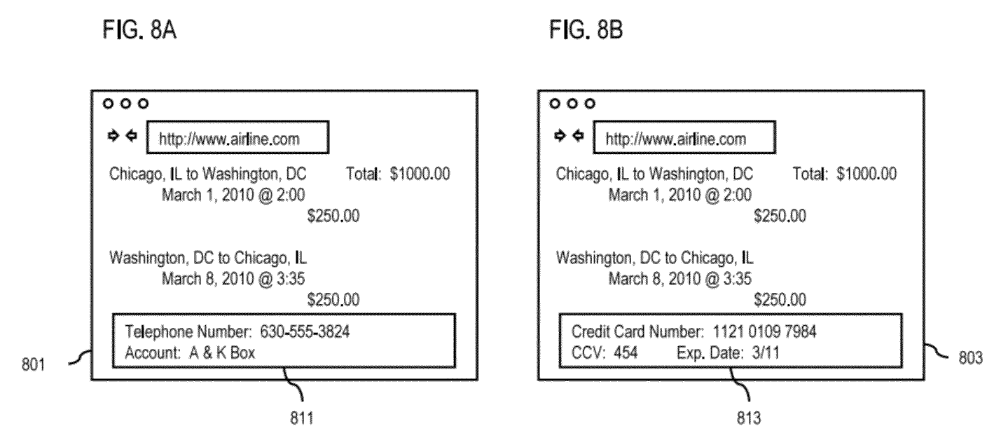

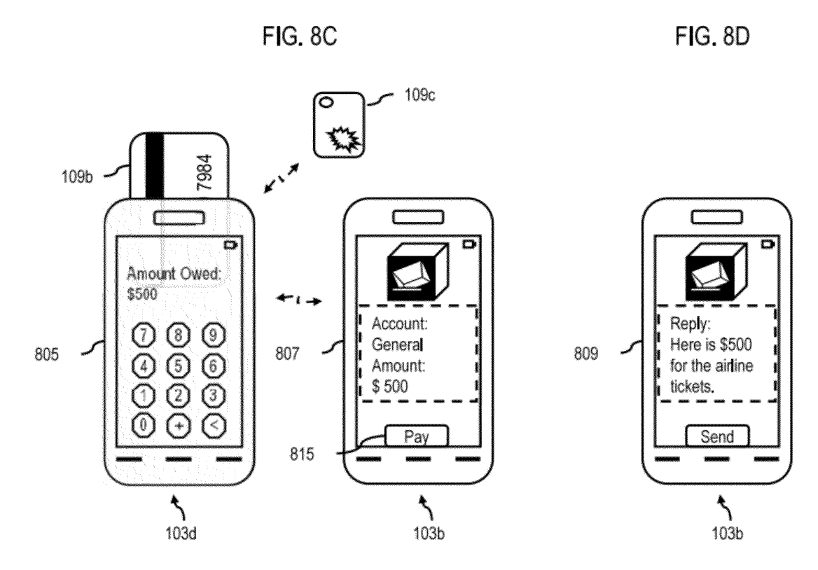

FIGS. 8A-8D are diagrams of user interfaces utilized in the processes of FIG. 7, according to various embodiments. In FIG. 8A, indicator 801 illustrates the user interface of a UE 103 displaying a website that is compatible with the asset sharing platform 101. Indicator 811 illustrates the prompts that the user enters the information associating the UE 103 that has the associated account to transfer of assets. In one embodiment, the indictor 811 indicates the telephone number and account name associated with the UE 103 and the asset sharing client 113 that is associated with the transfer. In FIG. 8B, indicator 803 illustrates the user interface of a UE 103 displaying a website that is incompatible with the asset sharing platform 101. Indicator 813 illustrates the prompts that the user enters the temporary information linked to the account generated by the asset sharing platform 101 for the particular transaction. In one embodiment, the temporary information linked to the account is in the form of a credit card number, CCV number and expiration date.

In FIG. 8C, indicator 805 illustrates the user interface of the UE 103d, acting as a vendor tool, while requesting a transfer of assets. In one embodiment, the UE 103d receives payment via an account tool 109b formatted according to the structure of a credit card. In one embodiment, the UE 103d receives payment via an account tool 109c formatted according to the structure of an NFC key fob. In one embodiment, the UE 103d receives payment via the UE 103b capable of conducting NFC actions. As seen in FIG. 8C, the NFC capable UE 103b includes indicator 807 that displays the account from which the transfer will originate from and the amount of the transfer. The UE 103b also includes indicator 815 that activates the payment through the NFC.

In FIG. 8D, indicator 809 illustrates the user interface of the UE 103b in response to a message prompt to make a payment via a communication. In one embodiment, the prompt is in the form of a SMS. Alternatively, the indicator 809 illustrates a message to make payment via a communication that is not in response to a prompt if the term “Reply” is missing. In this embodiment, indicator 809 illustrates an SMS message that has the information required to make a transfer through the asset sharing platform 101.

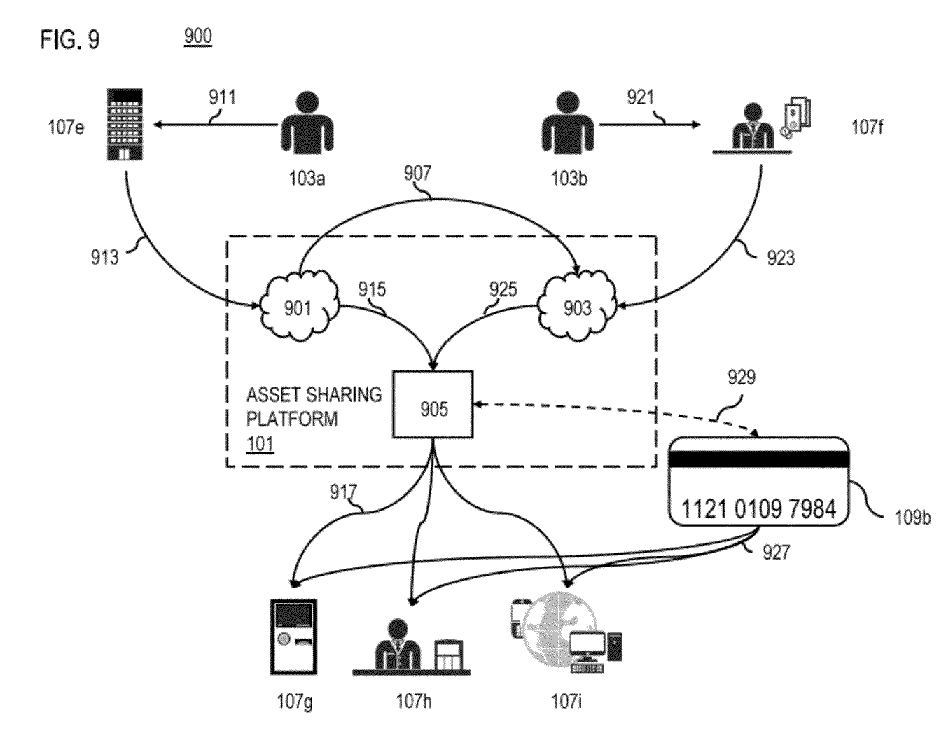

In FIG. 9, one embodiment of the system 100 is described in detail in context of the process 900. In step 911, a user using a UE 103a loaded with an asset sharing client 113a instructs a banking service provider 107e to transfer assets into the asset sharing platform 101. In step 913, the banking service provider 107e transfers the requested some of assets in a specified account 901 held through the asset sharing platform 101. In step 921, another user using a UE 103b with an asset sharing client 113b goes to an asset sharing agent service provider 1077f and provides cash to the asset sharing agent service provider 1077f to transfer into the asset sharing platform 101. In step 923, the asset sharing agent service provider 1077f transfers a representation of the cash into the other user's account 903 held through the asset sharing platform 101. In step 907, the first user using the UE 103a requests to share a self-created account 905 with the second user using the UE 103b. In this embodiment, the request to share the account is in the form of a SMS and requires no external authorization to complete the sharing. After accepting the request to share the account 905, in step 915, the first user using the UE 103a transfers assets into the shared account 905 from account 901. In step 925, the second user using the UE 103b also transfers assets into the shared account from account 903. In step 929, either one of the first user with the UE 103a or the second user with the UE 103b can associate the shared account 905 with an account tool 109b. In step 917, either one of the first user with the UE 103a or the second user with the UE 103b can transfer money out of the shared account at a ticket machine service provider 107g, at an in store service provider 107h, and at an online service provider 107i. In step 927, either one of the first user or the second user can transfer money out of the shared account using the account tool 109b at a ticket machine service provider 107g, at an in-store service provider 107h, and at an online service provider 107i.

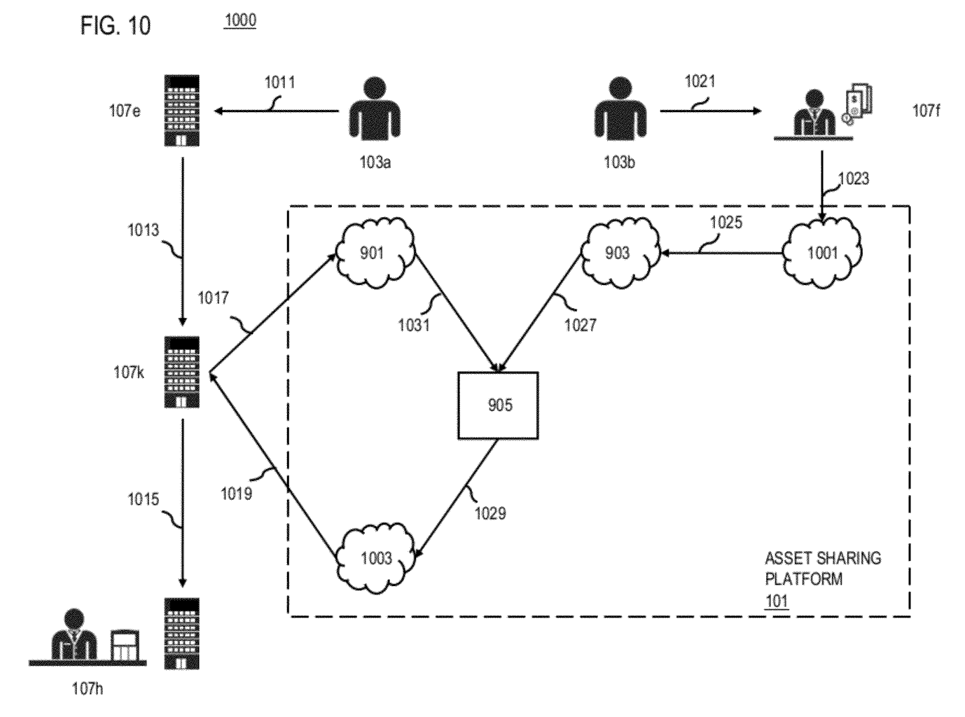

In FIG. 10, one embodiment of the system 100 is described in greater detail in context of the process 1000. In step 1011, a first user associated with a UE 103a deposits money at a banking service provider 107e and requests that the banking service provider 107e transfer the money to associate with the first user's asset sharing client 113a. In step 1013, the banking service provider 107e transfers the money to an asset sharing service provider 107k to transfer into the first user's asset sharing client 113. In step 1017, the asset sharing service provider 107k transfers the money into the asset sharing platform 101 and associates the money with an account 901 associated with the first user's asset sharing client 113a and UE 103a. In step 1021, a second user associated with a UE 103b gives money to an asset sharing agent service provider 107f and requests that the asset sharing agent service provider 107f transfers the money to associate with the second user's asset sharing client 113b. In step 1023, the asset sharing agent service provider 107f transfers the money as a representation into an account 1001 of the asset sharing agent service provider 107f held though the asset sharing platform 101. In step 1025, the asset sharing agent service provider 107f transfers the money from the account 1001 to the account 903 associated with the second user. In step 1031, the first user transfers money held in the account 901 through the asset sharing platform 101 into the account 905, which is shared with the second user with substantially equal rights. In step 1027, the second user transfers money held in the account 903 through the asset sharing platform 101 into the account 905, which is shared with the first user with substantially equal rights. In step 1029, either one of the first user or the second user, or a combination thereof, decides to make a purchase using the funds in the shared account 905 at a retail service provider 107h and transfers money into an account 1003 held through the asset sharing platform 101 by the retail service provider 107h. In step 1019, the asset sharing service provider 107k withdraws the representation of the money from the account 1003 of the retail service provider 107h in response to the retail service provider 107j wanting to withdraw the money. In step 1015, the asset sharing service provider 107k transfers the money to the retail service provider 107h.

The processes described herein for sharing a self-created account for storing assets may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

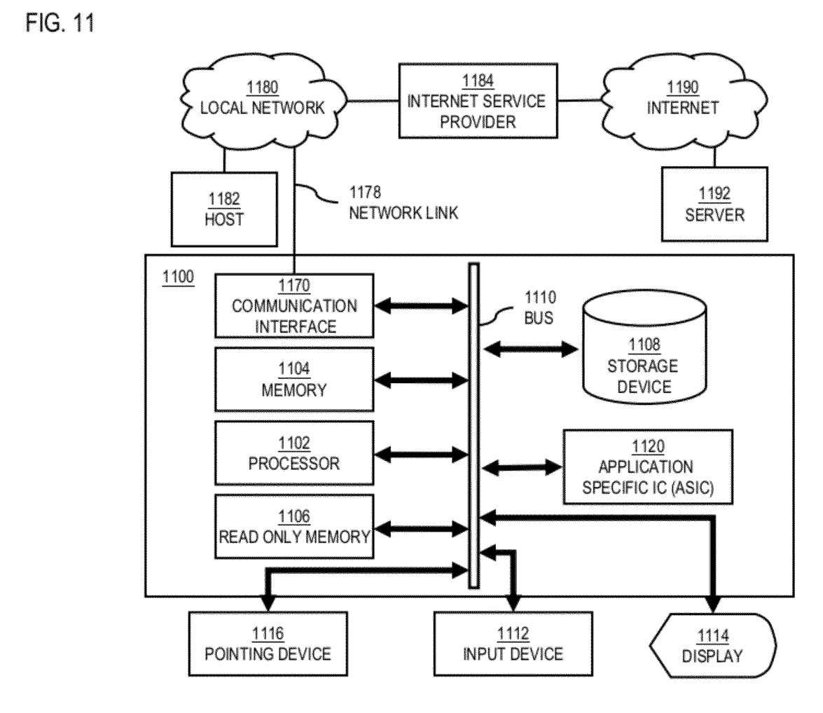

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to sharing a self-created account for storing assets as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of sharing a self-created account for storing assets.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to sharing a self-created account for storing assets. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or any other dynamic storage device, stores information including processor instructions for sharing a self-created account for storing assets. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for sharing a self-created account for storing assets, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for sharing a self-created account for storing assets to the UE 103.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to share a self-created account for storing assets as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of sharing a self-created account for storing assets.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to share a self-created account for storing assets. The memory 1205 also stores the data associated with or generated by the execution of the inventive steps.

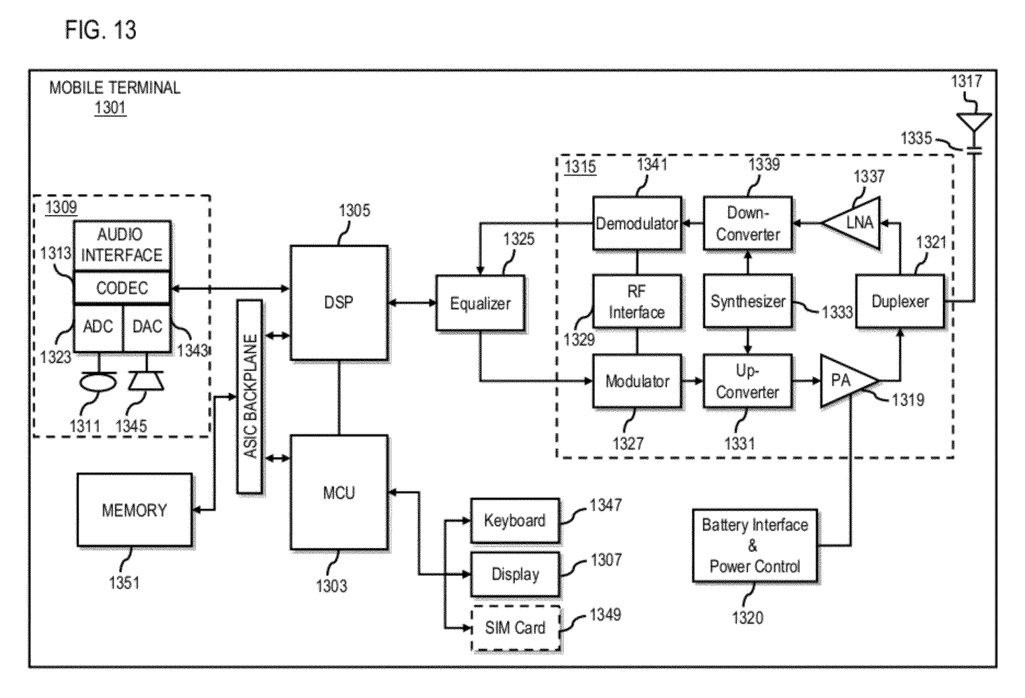

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of sharing a self-created account for storing assets. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of sharing a self-created account for storing assets. The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to share a self-created account for storing assets. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one account for storing a representation of one or more associated assets, the at least one account being a self-created account associated with at least one device; and
a sharing of the at least one account with at least one other device to enable collective access to the at least one account by the at least one device and the at least one other device with substantially equal rights.

2. A method of claim 1, wherein the at least one account is created, managed, shared, or a combination thereof by the at least one device, the at least one other device, or a combination thereof without external authorization.

3. A method of claim 1, wherein the (1) data and/or (2) information and/or (3) at least one signal are further based, at least in part, on the following:
a setting of at least one property associated with the at least one account,
wherein the at least one property defines at least one of a maximum or minimum value for the one or more associated assets, a maximum or minimum transfer amount of the one or more associated assets, an identification challenge to access the at least one account, a lifespan of the at least one account, a purpose of the at least one account, a context for accessing the at least one account, or a combination thereof.

4. A method of claim 1, wherein the (1) data and/or (2) information and/or (3) at least one signal are further based, at least in part, on the following:
a processing of the at least one property to determine whether to delete the at least one account, inactivate the at least one account, authorize one or more activities associated with the account, or a combination thereof.

5. A method of claim 1, wherein the (1) data and/or (2) information and/or (3) at least one signal are further based, at least in part, on the following:
an association of the at least one account with one or more account tools,
wherein access to the at least one account is via the one or more account tools.

6. A method of claim 1, wherein the (1) data and/or (2) information and/or (3) at least one signal are further based, at least in part, on the following:
a creation of one or more reports of one or more activities associated with the at least one account.

7. A method of claim 6, wherein the (1) data and/or (2) information and/or (3) at least one signal are further based, at least in part, on the following:
a transmission of the one or more reports to the at least one device, the at least one other device, or a combination thereof is substantially real-time, periodically, on demand, according to a schedule, or a combination thereof.

8. A method of claim 1, wherein the (1) data and/or (2) information and/or (3) at least one signal are further based, at least in part, on the following:
a closing of the at least one account; and
a distribution of a remaining portion of the one or more assets to the at least one device, the at least one other device, or a combination thereof.

9. A method of claim 1, wherein the (1) data and/or (2) information and/or (3) at least one signal are further based, at least in part, on the following:
one or more activities with respect to the at least one account; and
a processing of the one or more activities to determine a level of authentication to apply for completing the one or more activities.

10. A method of claim 1, wherein the one or more assets include, at least in part, money, cellular phone minutes, game credits, bandwidth allotments.

11. An apparatus comprising:
at least one processor; and
at least one memory including computer program code,
the at least one memory and the computer program code configured to, with the at least one processor, cause the apparatus to perform at least the following,
determine at least one account for storing a representation of one or more associated assets, the at least one account being a self-created account associated with at least one device; and
cause, at least in part, a sharing of the at least one account with at least one other device to enable collective access to the at least one account by the at least one device and the at least one other device with substantially equal rights.

12. A apparatus of claim 11, wherein the at least one account is created, managed, shared, or a combination thereof by the at least one device, the at least one other device, or a combination thereof without external authorization.

13. An apparatus of claim 11, wherein the apparatus is further caused to:
cause, at least in part, a setting of at least one property associated with the at least one account,
wherein the at least one property defines at least one of a maximum or minimum value for the one or more associated assets, a maximum or minimum transfer amount of the one or more associated assets, an identification challenge to access the at least one account, a lifespan of the at least one account, a purpose of the at least one account, a context for accessing the at least one account, or a combination thereof.

14. An apparatus of claim 11, wherein the apparatus is further caused to:
process and/or facilitate a processing of the at least one property to determine whether to delete the at least one account, inactivate the at least one account, authorize one or more activities associated with the account, or a combination thereof.

15. An apparatus of claim 11, wherein the apparatus is further caused to:
cause, at least in part, an association of the at least one account with one or more account tools,
wherein access to the at least one account is via the one or more account tools.

16. An apparatus of claim 11, wherein the apparatus is further caused to:
cause, at least in part, creation of one or more reports of one or more activities associated with the at least one account.

17. An apparatus of claim 16, wherein the apparatus is further caused to:
cause, at least in part, a transmission of the one or more reports to the at least one device, the at least one other device, or a combination thereof is substantially real-time, periodically, on demand, according to a schedule, or a combination thereof.

18. An apparatus of claim 11, wherein the apparatus is further caused to:
determine to close the at least one account; and
causing, at least in part, a distribution of a remaining portion of the one or more assets to the at least one device, the at least one other device, or a combination thereof.

19. An apparatus of claim 11, wherein the apparatus is further caused to:
determine one or more activities with respect to the at least one account; and
process and/or facilitate a processing of the one or more activities to determine a level of authentication to apply for completing the one or more activities.

20. An apparatus of claim 11, wherein the one or more assets include, at least in part, money, cellular phone minutes, game credits, bandwidth allotments.

21-47. (canceled)
